(19) United States
(12) Patent Application Publication
(10) Pub. No.: US 2009/0123671 A1
(43) Pub. Date: May 14, 2009

(54) Fir plank structure and processing method thereof

(76) Inventors: Zhongdi Huang, Youxi (CN); Yi Chen, Youxi (CN); Yufeng Deng, Youxi (CN); Xinjin Chen, Youxi (CN)

Correspondence Address: SAM CHEN, 7F-1, 293, ROOSEVELT ROAD, SEC 3, TAIPEI, TW

(21) Appl. No.: 11/938,301

(22) Filed: Nov. 12, 2007

(51) Int. Cl. B05D 3/02; B05D 1/36; B05D 1/38

(52) U.S. Cl. 428/22; 427/385.5; 427/408

(57) ABSTRACT

A processing method of the fir plank structure in accordance with the present invention includes the following steps. The wood is shaped to a plank. A sealing layer is applied to an outer periphery of the shaped plank. The sealing layer is quickly cured by heating and baking under 100° C. or slowly and automatically cured under room temperature. A bottom layer is applied to an outer periphery of the sealing layer. The bottom layer is quickly cured by heating and baking under 100° C. or slowly and automatically cured under room temperature. A surface layer is applied to an outer periphery of the bottom layer.

### BACKGROUND OF THE INVENTION

1. Field of the Invention

The present invention relates to a plank structure, and more particularly to a fir plank structure and processing method thereof.

2. Description of Related Art

The importance and the difficulty of processing fir plank are to solving the problem of oozing oil form the surface of the fir wood. A conventional fir plank processing method increases several steps to the source material mending process.

Step 1: The scars on the source material are mended by adhering ordinary wood flour thereon.

Step 2: A sealing paint is applied to the mended scars, the pith and the portions having dark color.

Step 3 is coating process. The coating material contains coating glue and calcium carbonate.

The above steps can solve the problem of oozing oil form the surface of the fir wood. However, some disadvantages are still existed as follow.

1. Mending scars and applying sealing paint to the mended scars, the pith and the portions having dark color are a complicated skill and take a lot of time and cost.

2. The specific gravity and the shrink ratio of the coating material are different from that of the fir wood. Consequently, the coating may be chipped off when the environment is changed, especially temperature.

The present invention has arisen to mitigate and/or obviate the disadvantages of the conventional fir plank structure and the processing thereof.

### SUMMARY OF THE INVENTION

The main objective of the present invention is to provide an improved fir plank structure and a processing method for manufacturing the fir plank structure without mending the scars of the fir wood.

To achieve the objective, the fir plank structure in accordance with the present invention comprises a shaped plank and a sealing layer applied to an outer periphery of the shaped plank. The sealing layer has a thickness over 0.2 mm and is a mixture containing wood powder, glue and calcium carbonate. A weight ratio of the wood powder, the calcium carbonate and the glue is 1:0.2-0.4:0.5-0.8. A surface layer is applied to an outer periphery of the sealing layer. A hydrous ratio of the wood powder is under 15% and the wood powder has a particle size mesh ranged from 100 to 600 mesh sieve. The glue is selected from the group consisting of amino resin adhesive, alkene high polymer adhesive and polyurethane adhesive.

A processing method of the fir plank structure in accordance with the present invention comprises the following steps. The wood is shaped to a plank. A sealing layer is applied to an outer periphery of the shaped plank. The sealing layer is quickly cured by heating and baking under 100° C. or slowly and automatically cured under room temperature. A surface layer is applied to an outer periphery of the sealing layer.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional view of a first embodiment of a fir plank structure in accordance with the present invention;

FIG. 2 is a cross-sectional view of a second embodiment of a fir plank structure in accordance with the present invention;

FIG. 3 is a cross-sectional view of a third embodiment of a fir plank structure in accordance with the present invention;

FIG. 4 is a flow chart of a processing method of the second embodiment in accordance with the present invention; and

FIG. 5 is a flow chart of a processing method of the third embodiment in accordance with the present invention.

### DETAILED DESCRIPTION OF THE INVENTION

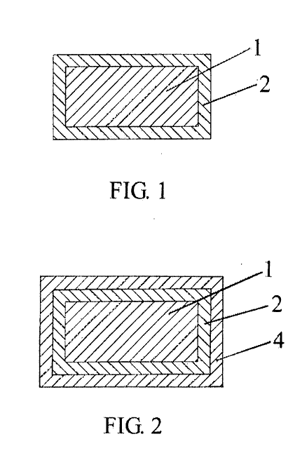

Referring to the drawings and initially to FIG. 1, a fir plank structure in accordance with the present invention comprises shaped plank (1) having a sealing layer (2) applied on the outer periphery thereof. The sealing layer (2) is a mixture containing wood powder and glue or a mixture containing wood powder, calcium carbonate and glue. The glue, hereinbefore, is amino resin adhesive, alkene high polymer adhesive, polyurethane adhesive or a mixture containing two or three material that is selected from amino resin adhesive, alkene high polymer adhesive and polyurethane adhesive.

The mixture, containing wood powder and glue, can seal and absorbing the oozing oil from the surface of fir wood. In addition, the shrink ratio of the wood powder if similar to that of the fir wood such that the sealing layer (2) maintains a stability and does not clip off when the environment and the temperature is changed.

The calcium carbonate, hereinbefore, is used as an auxiliary material to make fir plank has a bright surface. The common purpose of the amino resin adhesive, the alkene high polymer adhesive and the polyurethane adhesive is to provide an adhering effect. However, the amino resin adhesive, the alkene high polymer adhesive and the polyurethane adhesive respectively have its unique properties. The amino resin adhesive has a good waterproof property, the alkene high polymer adhesive has a low solidify temperature and the polyurethane adhesive can promote the quality of the surface of the fir plank.

In the preferred embodiment of the present invention, the sealing layer (2) has a thickness over 0.2 mm for ensuring the effect of absorbing the oozing oil from the surface of fir wood.

The sealing layer (2) has various embodiments as follow.

### EXAMPLE 1

The sealing layer (2) is constituted by a mixture that contains wood powder and amino resin adhesive. The hydrous ratio of the wood powder is 15% and the wood powder has a particle size mesh of 100 mesh sieve. The weight ratio of the wood powder and the amino resin adhesive is 1:0.5.

The amino resin adhesive can be replaced by the alkene high polymer adhesive or the polyurethane adhesive.

Effect: the wood powder is thick, the sealing layer (2) is thick, the adhesion is second level, the finished surface is rough and the sealant effect is good.

### EXAMPLE 2

The sealing layer (2) is constituted by a mixture that contains wood powder and alkene high polymer adhesive. The hydrous ratio of the wood powder is 8% and the wood powder has a particle size mesh of 600 mesh sieve. The weight ratio of the wood powder and the alkene high polymer adhesive is 1:8.

The alkene high polymer adhesive can be replaced by the amino resin adhesive or the polyurethane adhesive.

Effect: the wood powder is thin, the sealing layer (2) is thin, the adhesion is first level, the finished surface is refined and the sealant effect is good.

### EXAMPLE 3

The sealing layer (2) is constituted by a mixture that contains wood powder and polyurethane adhesive. The hydrous ratio of the wood powder is 1% and the wood powder has a particle size mesh of 300 mesh sieve. The weight ratio of the wood powder and the amino resin adhesive is 1:4.

The polyurethane adhesive can be replaced by the amino resin adhesive or the alkene high polymer adhesive.

Effect: the wood powder is moderate, the sealing layer (2) is moderate, the adhesion is first level and the sealant effect is good.

### EXAMPLE 4

The sealing layer (2) is constituted by a mixture that contains wood powder, amino resin adhesive and calcium carbonate. The hydrous ratio of the wood powder is 5% and the wood powder has a particle size mesh of 600 mesh sieve. The weight ratio of the wood powder, the amino resin adhesive and the calcium carbonate is 1:0.5:0.2.

The amino resin adhesive can be replaced by the alkene high polymer adhesive or the polyurethane adhesive.

Effect: the wood powder is thin, the sealing layer (2) is thin, the adhesion is second level, the finished surface is refined and the sealant effect is good.

### EXAMPLE 5

The sealing layer (2) is constituted by a mixture that contains wood powder, alkene high polymer adhesive and calcium carbonate. The hydrous ratio of the wood powder is 5% and the wood powder has a particle size mesh of 600 mesh sieve. The weight ratio of the wood powder, the alkene high polymer adhesive and the calcium carbonate is 1:8:4.

The alkene high polymer adhesive can be replaced by the amino resin adhesive or the polyurethane adhesive.

Effect: the wood powder is thin, the sealing layer (2) is thin, the adhesion is first level, the finished surface is refined and the sealant effect is good.

### EXAMPLE 6

The sealing layer (2) is constituted by a mixture that contains wood powder, polyurethane adhesive and calcium carbonate. The hydrous ratio of the wood powder is 8% and the wood powder has a particle size mesh of 600 mesh sieve. The weight ratio of the wood powder, the polyurethane adhesive and the calcium carbonate is 1:4:2.

The polyurethane adhesive can be replaced by the amino resin adhesive or the alkene high polymer adhesive.

Effect: the wood powder is thin, the sealing layer (2) is thin, the adhesion is first level, the finished surface is refined and the sealant effect is good.

### EXAMPLE 7

The sealing layer (2) is constituted by a mixture that contains wood powder, amino resin adhesive and alkene high polymer adhesive. The hydrous ratio of the wood powder is 8% and the wood powder has a particle size mesh of 600 mesh sieve. The weight ratio of the wood powder, the amino resin adhesive and the alkene high polymer adhesive is 202:100:1.

The amino resin adhesive can be replaced by the alkene high polymer adhesive and the alkene high polymer adhesive can be replaced by the polyurethane adhesive.

Effect: the wood powder is thin, the sealing layer (2) is thin, the adhesion is second level, the finished surface is refined and the sealant effect is good.

### EXAMPLE 8

The sealing layer (2) is constituted by a mixture that contains wood powder, amino resin adhesive and alkene high polymer adhesive. The hydrous ratio of the wood powder is 8% and the wood powder has a particle size mesh of 600 mesh sieve. The weight ratio of the wood powder, the amino resin adhesive and the alkene high polymer adhesive is 3:4:20.

The amino resin adhesive can be replaced by the alkene high polymer adhesive and the alkene high polymer adhesive can be replaced by the polyurethane adhesive.

Effect: the wood powder is thin, the sealing layer (2) is thin, the adhesion is first level, the finished surface is refined and the sealant effect is good.

### EXAMPLE 9

The sealing layer (2) is constituted by a mixture that contains wood powder, amino resin adhesive and alkene high polymer adhesive. The hydrous ratio of the wood powder is 8% and the wood powder has a particle size mesh of 600 mesh sieve. The weight ratio of the wood powder, the amino resin adhesive and the alkene high polymer adhesive is 3:4:8.

The amino resin adhesive can be replaced by the alkene high polymer adhesive and the alkene high polymer adhesive can be replaced by the polyurethane adhesive.

Effect: the wood powder is thin, the sealing layer (2) is thin, the adhesion is first level, the finished surface is refined and the sealant effect is good.

### EXAMPLE 10

The sealing layer (2) is constituted by a mixture that contains wood powder, amino resin adhesive, alkene high polymer adhesive and calcium carbonate. The hydrous ratio of the wood powder is 8% and the wood powder has a particle size mesh of 600 mesh sieve. The weight ratio of the wood powder, the amino resin adhesive, the alkene high polymer adhesive and the calcium carbonate is 1010:500:5:202.

The amino resin adhesive can be replaced by the alkene high polymer adhesive and the alkene high polymer adhesive can be replaced by the polyurethane adhesive.

Effect: the wood powder is thin, the sealing layer (2) is thin, the adhesion is second level, the finished surface is refined and the sealant effect is good.

### EXAMPLE 11

The sealing layer (2) is constituted by a mixture that contains wood powder, amino resin adhesive, alkene high polymer adhesive and calcium carbonate. The hydrous ratio of the wood powder is 8% and the wood powder has a particle size mesh of 600 mesh sieve. The weight ratio of the wood powder, the amino resin adhesive, the alkene high polymer adhesive and the calcium carbonate is 3:4:20:6.

The amino resin adhesive can be replaced by the alkene high polymer adhesive and the alkene high polymer adhesive can be replaced by the polyurethane adhesive.

Effect: the wood powder is thin, the sealing layer (2) is thin, the adhesion is first level, the finished surface is refined and the sealant effect is good.

### EXAMPLE 12

The sealing layer (2) is constituted by a mixture that contains wood powder, amino resin adhesive, alkene high polymer adhesive and calcium carbonate. The hydrous ratio of the wood powder is 8% and the wood powder has a particle size mesh of 600 mesh sieve. The weight ratio of the wood powder, the amino resin adhesive, the alkene high polymer adhesive and the calcium carbonate is 3:4:8:12.

The amino resin adhesive can be replaced by the alkene high polymer adhesive and the alkene high polymer adhesive can be replaced by the polyurethane adhesive.

Effect: the wood powder is thin, the sealing layer (2) is thin, the adhesion is first level, the finished surface is refined and the sealant effect is good.

### EXAMPLE 13

The sealing layer (2) is constituted by a mixture that contains wood powder, amino resin adhesive, alkene high polymer adhesive and polyurethane adhesive. The hydrous ratio of the wood powder is 8% and the wood powder has a particle size mesh of 600 mesh sieve. The weight ratio of the wood powder, the amino resin adhesive, the alkene high polymer adhesive and the polyurethane adhesive is 204:100:1:1.

Effect: the wood powder is thin, the sealing layer (2) is thin, the adhesion is second level, the finished surface is refined and the sealant effect is good.

### EXAMPLE 14

The sealing layer (2) is constituted by a mixture that contains wood powder, amino resin adhesive, alkene high polymer adhesive and polyurethane adhesive. The hydrous ratio of the wood powder is 8% and the wood powder has a particle size mesh of 600 mesh sieve. The weight ratio of the wood powder, the amino resin adhesive, the alkene high polymer adhesive and the polyurethane adhesive is 11:8:40:40.

Effect: the wood powder is thin, the sealing layer (2) is thin, the adhesion is first level, the finished surface is refined and the sealant effect is good.

### EXAMPLE 15

The sealing layer (2) is constituted by a mixture that contains wood powder, amino resin adhesive, alkene high polymer adhesive and polyurethane adhesive. The hydrous ratio of the wood powder is 8% and the wood powder has a particle size mesh of 600 mesh sieve. The weight ratio of the wood powder, the amino resin adhesive, the alkene high polymer adhesive and the polyurethane adhesive is 5:4:8:8.

Effect: the wood powder is thin, the sealing layer (2) is thin, the adhesion is first level, the finished surface is refined and the sealant effect is good.

### EXAMPLE 16

The sealing layer (2) is constituted by a mixture that contains wood powder, amino resin adhesive, alkene high polymer adhesive, polyurethane adhesive and calcium carbonate. The hydrous ratio of the wood powder is 8% and the wood powder has a particle size mesh of 600 mesh sieve. The weight ratio of the wood powder, the amino resin adhesive, the alkene high polymer adhesive, the polyurethane adhesive, and the calcium carbonate is 1020:500:5:5:204.

Effect: the wood powder is thin, the sealing layer (2) is thin, the adhesion is second level, the finished surface is refined and the sealant effect is good.

### EXAMPLE 17

The sealing layer (2) is constituted by a mixture that contains wood powder, amino resin adhesive, alkene high polymer adhesive, polyurethane adhesive and calcium carbonate. The hydrous ratio of the wood powder is 8% and the wood powder has a particle size mesh of 600 mesh sieve. The weight ratio of the wood powder, the amino resin adhesive, the alkene high polymer adhesive, the polyurethane adhesive, and the calcium carbonate is 11:8:40:40:44.

Effect: the wood powder is thin, the sealing layer (2) is thin, the adhesion is first level, the finished surface is refined and the sealant effect is good.

### EXAMPLE 18

The sealing layer (2) is constituted by a mixture that contains wood powder, amino resin adhesive, alkene high polymer adhesive, polyurethane adhesive and calcium carbonate. The hydrous ratio of the wood powder is 8% and the wood powder has a particle size mesh of 600 mesh sieve. The weight ratio of the wood powder, the amino resin adhesive, the alkene high polymer adhesive, the polyurethane adhesive, and the calcium carbonate is 5:4:8:8:10.

Effect: the wood powder is thin, the sealing layer (2) is thin, the adhesion is first level, the finished surface is refined and the sealant effect is good.

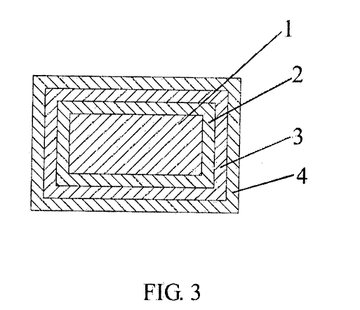

With reference to FIG. 3, the fir plank structure in accordance with the present invention further comprises a bottom layer (3) applied to an outer periphery of the sealing layer (2) for providing a strength, hardness, elasticity, waterproof or a refined surface to the fir plank. The bottom layer (3) is constituted by a mixture containing white wood powder and glue, calcium carbonate and glue, or white wood powder, calcium carbonate and glue.

The glue of the bottom layer (3), hereinbefore, is amino resin adhesive, alkene high polymer adhesive, polyurethane adhesive or the mixture containing at least two mixed adhesives that is selected from the amino resin adhesive, alkene high polymer adhesive and the polyurethane adhesive.

The bottom layer (3) has various embodiments as follow.

### EXAMPLE 19

The bottom layer (3) is constituted by a mixture that contains white wood powder and amino resin adhesive. The weight ratio of the white wood powder and the amino resin adhesive is 1:0.5.

The amino resin adhesive can be replaced by the alkene high polymer adhesive or the polyurethane adhesive.

Effect: the bottom layer (3) is easily to be colored and has a good elasticity. The adhesion of the bottom layer (3) is second level.

### EXAMPLE 20

The bottom layer (3) is constituted by a mixture that contains white wood powder and alkene high polymer adhesive. The weight ratio of the white wood powder and the alkene high polymer adhesive is 1:8.

The alkene high polymer adhesive can be replaced by the amino resin adhesive or the polyurethane adhesive.

Effect: the bottom layer (3) is easily to be colored and has a good elasticity. The adhesion of the bottom layer (3) is first level.

### EXAMPLE 21

The bottom layer (3) is constituted by a mixture that contains white wood powder and polyurethane adhesive. The weight ratio of the white wood powder and the polyurethane adhesive is 1:4.

The polyurethane adhesive can be replaced by the amino resin adhesive or the alkene high polymer adhesive.

Effect: the bottom layer (3) is easily to be colored and has a good elasticity. The adhesion of the bottom layer (3) is first level.

### EXAMPLE 22

The bottom layer (3) is constituted by a mixture that contains white wood powder, amino resin adhesive and alkene high polymer adhesive. The weight ratio of the white wood powder, the amino resin adhesive and the alkene high polymer adhesive is 202:100:1.

The amino resin adhesive can be replaced by the alkene high polymer adhesive and the alkene high polymer adhesive can be replaced by the polyurethane adhesive.

Effect: the bottom layer (3) is easily to be colored and has a good elasticity. The adhesion of the bottom layer (3) is second level.

### EXAMPLE 23

The bottom layer (3) is constituted by a mixture that contains white wood powder, amino resin adhesive and alkene high polymer adhesive. The weight ratio of the white wood powder, the amino resin adhesive and the alkene high polymer adhesive is 3:4:20.

The amino resin adhesive can be replaced by the alkene high polymer adhesive and the alkene high polymer adhesive can be replaced by the polyurethane adhesive.

Effect: the bottom layer (3) is easily to be colored and has a good elasticity. The adhesion of the bottom layer (3) is first level.

### EXAMPLE 24

The bottom layer (3) is constituted by a mixture that contains white wood powder, amino resin adhesive and alkene high polymer adhesive. The weight ratio of the white wood powder, the amino resin adhesive and the alkene high polymer adhesive is 3:4:8.

The amino resin adhesive can be replaced by the alkene high polymer adhesive and the alkene high polymer adhesive can be replaced by the polyurethane adhesive.

Effect: the bottom layer (3) is easily to be colored and has a good elasticity. The adhesion of the bottom layer (3) is first level.

### EXAMPLE 25

The bottom layer (3) is constituted by a mixture that contains white wood powder, amino resin adhesive, alkene high polymer adhesive and polyurethane adhesive. The weight ratio of the white wood powder, the amino resin adhesive, the alkene high polymer adhesive and the polyurethane adhesive is 204:100:1:1.

Effect: the bottom layer (3) is easily to be colored and has a good elasticity. The adhesion of the bottom layer (3) is second level.

### EXAMPLE 26

The bottom layer (3) is constituted by a mixture that contains white wood powder, amino resin adhesive, alkene high polymer adhesive and polyurethane adhesive. The weight ratio of the white wood powder, the amino resin adhesive, the alkene high polymer adhesive and the polyurethane adhesive is 11:8:40:40.

Effect: the bottom layer (3) is easily to be colored and has a good elasticity. The adhesion of the bottom layer (3) is first level.

### EXAMPLE 27

The bottom layer (3) is constituted by a mixture that contains white wood powder, amino resin adhesive, alkene high polymer adhesive and polyurethane adhesive. The weight ratio of the white wood powder, the amino resin adhesive, the alkene high polymer adhesive and the polyurethane adhesive is 5:4:8:8.

Effect: the bottom layer (3) is easily to be colored and has a good elasticity. The adhesion of the bottom layer (3) is first level.

### EXAMPLE 28

The bottom layer (3) is constituted by a mixture that contains calcium carbonate and amino resin adhesive. The weight ratio of the calcium carbonate and the amino resin adhesive is 5:1.

The amino resin adhesive can be replaced by the alkene high polymer adhesive or the polyurethane adhesive.

Effect: the bottom layer (3) is easily to be colored and has a good hardness. The adhesion of the bottom layer (3) is first level.

### EXAMPLE 29

The bottom layer (3) is constituted by a mixture that contains calcium carbonate and alkene high polymer adhesive. The weight ratio of the calcium carbonate and the alkene high polymer adhesive is 2:1.

The alkene high polymer adhesive can be replaced by the amino resin adhesive or the polyurethane adhesive.

Effect: the bottom layer (3) is easily to be colored and has a good hardness. The adhesion of the bottom layer (3) is first level.

### EXAMPLE 30

The bottom layer (3) is constituted by a mixture that contains calcium carbonate and polyurethane adhesive. The weight ratio of the calcium carbonate and the polyurethane adhesive is 1:1.

The polyurethane adhesive can be replaced by the amino resin adhesive or the alkene high polymer adhesive.

Effect: the bottom layer (3) is easily to be colored and has a good hardness. The adhesion of the bottom layer (3) is first level.

### EXAMPLE 31

The bottom layer (3) is constituted by a mixture that contains calcium carbonate, amino resin adhesive and alkene high polymer adhesive. The weight ratio of the calcium carbonate, the amino resin adhesive and the alkene high polymer adhesive is 505:100:1.

The amino resin adhesive can be replaced by the alkene high polymer adhesive and the alkene high polymer adhesive can be replaced by the polyurethane adhesive.

Effect: the bottom layer (3) is easily to be colored and has a good hardness. The adhesion of the bottom layer (3) is second level.

### EXAMPLE 32

The bottom layer (3) is constituted by a mixture that contains calcium carbonate, amino resin adhesive and alkene high polymer adhesive. The weight ratio of the calcium carbonate, the amino resin adhesive and the alkene high polymer adhesive is 6:1:5.

The amino resin adhesive can be replaced by the alkene high polymer adhesive and the alkene high polymer adhesive can be replaced by the polyurethane adhesive.

Effect: the bottom layer (3) is easily to be colored and has a good hardness. The adhesion of the bottom layer (3) is first level.

### EXAMPLE 33

The bottom layer (3) is constituted by a mixture that contains calcium carbonate, amino resin adhesive and alkene high polymer adhesive. The weight ratio of the calcium carbonate, the amino resin adhesive and the alkene high polymer adhesive is 6:1:2.

The amino resin adhesive can be replaced by the alkene high polymer adhesive and the alkene high polymer adhesive can be replaced by the polyurethane adhesive.

Effect: the bottom layer (3) is easily to be colored and has a good hardness. The adhesion of the bottom layer (3) is first level.

### EXAMPLE 34

The bottom layer (3) is constituted by a mixture that contains calcium carbonate, amino resin adhesive, alkene high polymer adhesive and polyurethane adhesive. The weight ratio of the calcium carbonate, the amino resin adhesive, the alkene high polymer adhesive and the polyurethane adhesive is 510:100:1:1.

Effect: the bottom layer (3) is easily to be colored and has a good hardness. The adhesion of the bottom layer (3) is second level.

### EXAMPLE 35

The bottom layer (3) is constituted by a mixture that contains calcium carbonate, amino resin adhesive, alkene high polymer adhesive and polyurethane adhesive. The weight ratio of the calcium carbonate, the amino resin adhesive, the alkene high polymer adhesive and the polyurethane adhesive is 11:1:5:5.

Effect: the bottom layer (3) is easily to be colored and has a good hardness. The adhesion of the bottom layer (3) is first level.

### EXAMPLE 36

The bottom layer (3) is constituted by a mixture that contains calcium carbonate, amino resin adhesive, alkene high polymer adhesive and polyurethane adhesive. The weight ratio of the calcium carbonate, the amino resin adhesive, the alkene high polymer adhesive and the polyurethane adhesive is 10:1:2:2.

Effect: the bottom layer (3) is easily to be colored and has a good hardness. The adhesion of the bottom layer (3) is first level.

### EXAMPLE 37

The bottom layer (3) is constituted by a mixture that contains white wood powder, amino resin adhesive, alkene high polymer adhesive, polyurethane adhesive and calcium carbonate. The weight ratio of the wood powder, the amino resin adhesive, the alkene high polymer adhesive, the polyurethane adhesive and the calcium carbonate is 1020:500:5:5:204.

Effect: the bottom layer (3) is easily to be colored. The elasticity and the hardness of the bottom layer (3) are moderate and the adhesion of the bottom layer (3) is first level.

### EXAMPLE 38

The bottom layer (3) is constituted by a mixture that contains white wood powder, amino resin adhesive, alkene high polymer adhesive, polyurethane adhesive and calcium carbonate. The weight ratio of the wood powder, the amino resin adhesive, the alkene high polymer adhesive, the polyurethane adhesive and the calcium carbonate is 11:8:40:40:44.

Effect: the bottom layer (3) is easily to be colored. The elasticity and the hardness of the bottom layer (3) are moderate and the adhesion of the bottom layer (3) is first level.

### EXAMPLE 39

The bottom layer (3) is constituted by a mixture that contains white wood powder, amino resin adhesive, alkene high polymer adhesive, polyurethane adhesive and calcium carbonate. The weight ratio of the wood powder, the amino resin adhesive, the alkene high polymer adhesive, the polyurethane adhesive and the calcium carbonate is 5:4:8:8:10.

Effect: the bottom layer (3) is easily to be colored. The elasticity and the hardness of the bottom layer (3) are moderate and the adhesion of the bottom layer (3) is first level.

With reference to FIGS. 2 and 3, a surface layer (4) is applied to an outer periphery of the sealing layer (2) or the bottom layer (3). The surface layer (4) is high solids coating, UV curing resin coating, water based coating or powder coating. The surface layer (4) provides beautification and protection to the fir plank.

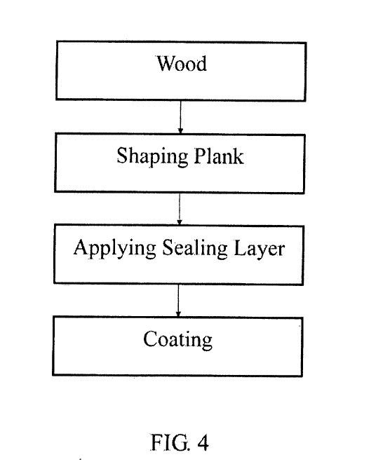

With reference to FIG. 4, a first processing method of the fir plank structure in accordance with the present invention comprises the following steps. The wood is shaped to a plank (1). A sealing layer (2) is applied to an outer periphery of the shaped plank (1). The sealing layer (2) is quickly cured by heating and baking under 100° C. or slowly and automatically cured under room temperature. A surface layer (4) is applied to an outer periphery of the sealing layer (2).

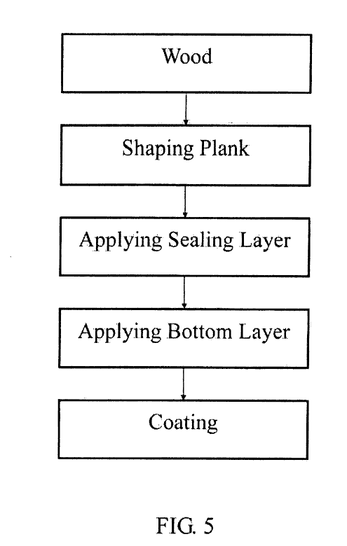

With reference to FIG. 5, a second processing method of the fir plank structure in accordance with the present invention comprises the following steps. The wood is shaped to a plank (1). A sealing layer (2) is applied to an outer periphery of the shaped plank (1). The sealing layer (2) is quickly cured by heating and baking under 100° C. or slowly and automatically cured under room temperature. A bottom layer (3) is applied to an outer periphery of the sealing layer (2). The bottom layer (3) is quickly cured by heating and baking under 100° C. or slowly and automatically cured under room temperature. A surface layer (4) is applied to an outer periphery of the bottom layer (3).

Although the invention has been explained in relation to its preferred embodiment, it is to be understood that many other possible modifications and variations can be made without departing from the spirit and scope of the invention as hereinafter claimed.

What is claimed is:

1. A fir plank structure comprising:
a shaped plank;
a sealing layer applied to an outer periphery of the shaped plank, the sealing layer having a thickness over 0.2 mm, the sealing layer being a mixture containing wood powder, glue and calcium carbonate, a weight ratio of the wood powder, the calcium carbonate and the glue being 1:0.2-0.4:0.5-0.8; and
a surface layer applied to an outer periphery of the sealing layer.

2. The fir plank structure as claimed in claim 1, wherein a hydrous ratio of the wood powder is under 15% and the wood powder has a particle size mesh ranged from 100 to 600 mesh sieve.

3. The fir plank structure as claimed in claim 1, wherein the glue is selected from the group consisting of amino resin adhesive, alkene high polymer adhesive and polyurethane adhesive.

4. The fir plank structure as claimed in claim 1 further comprising a bottom layer disposed between the sealing layer and the surface layer for providing a strength, hardness, elasticity, waterproof and a refined surface to the fir plank.

5. The fir plank structure as claimed in claim 4, wherein the bottom layer being a mixture containing white wood powder and glue.

6. The fir plank structure as claimed in claim 5, wherein the glue is selected from the group consisting of amino resin adhesive, alkene high polymer adhesive and polyurethane adhesive.

7. A processing method of a fir plank structure comprising the steps of:
shaping a wood to a plank;
applying a sealing layer to an outer periphery of the shaped plank, the sealing layer having a thickness over 0.2 mm, the sealing layer being a mixture containing wood powder, glue and calcium carbonate, a weight ratio of the wood powder, the calcium carbonate and the glue being 1:0.2-0.4:0.5-0.8; and
applying a surface layer to an outer periphery of the sealing layer.

8. The processing method as claimed in claim 7, wherein the glue is selected from the group consisting of amino resin adhesive, alkene high polymer adhesive and polyurethane adhesive.

9. The processing method as claimed in claim 7, wherein the sealing layer is quickly cured by heating and baking under 100° C.

10. The processing method as claimed in claim 7, wherein the sealing layer is slowly and automatically cured under room temperature.

11. The processing method as claimed in claim 7 further comprising a bottom layer disposed between the sealing layer and the surface layer for providing a strength, hardness, elasticity, waterproof and a refined surface to the fir plank.

12. The processing method as claimed in claim 7, wherein the bottom layer is quickly cured by heating and baking under 100° C.

10. The processing method as claimed in claim 7, wherein the bottom layer is slowly and automatically cured under room temperature.
